(19) United States
(12) Patent Application Publication
(10) Pub. No.: US 2010/0256005 A1
(43) Pub. Date: Oct. 7, 2010

(54) BLOOD GROUP ANTIBODY SCREENING

(76) Inventors: Juraj Petrik, Peebles (GB); Janine Scott Robb, Midlothian (GB); Nichola Mary O'Looney, Le Pecq (FR)

Correspondence Address: MYERS BIGEL SIBLEY & SAJOVEC, PO BOX 37428, RALEIGH, NC, 27627, US

(21) Appl. No.: 12/595,084

(22) PCT Filed: Apr. 8, 2008
(86) PCT No.: PCT/GB2008/001220

§ 371 Date: Jun. 22, 2010

(30) Foreign Application Priority Data
Apr. 10, 2007 (GB) 0706820.8

(51) Int. Cl. C40B 30/04; C40B 40/10; C40B 40/14

(52) U.S. Cl. 506/9; 506/18; 506/20

(57) ABSTRACT

An assay for the detection of antibodies to blood group antigens is provide and includes a solid substrate having immobilised thereon a fragment of cell membrane which presents a blood group antigen capable of binding to a blood group antibody. The cell fragments are preferably from red blood cells. The antigens may be immobilised in the form of an array of spots.

The present invention relates to blood transfusion testing, and more particularly to the detection of antibodies to blood group antigens. It also relates to an assay having preferred surface coatings.

The transfusion of blood or blood components is a commonly used medical practice. Blood products and devices used in blood transfusion testing must be manufactured and standardised in accordance with stringent requirements. Procedures are in place to ensure, as far as possible, that patients receive blood components that are safe for blood transfusion. Consequently, the area of blood transfusion and associated testing is a highly regulated area. Blood transfusion testing is covered by both United Kingdom and European law in the UK, and by regional quality systems and laws worldwide. Antibody screening for blood group and other antibodies forms a major part of this pre-transfusion testing, to both determine compatibility of donor and patient, and to minimise any subsequent immune response. The blood group antibody screen test is primarily used to detect whether blood samples contain antibodies to erythrocyte or red blood cells (RBC) surface blood group antigens. The production of such antibodies by an individual is most often caused by alloimmunisation, where antigen positive blood is introduced to an antigen negative individual, which may cause the production of antibodies to the non-self antigen. The transfusion of blood, or feto-maternal bleeding during pregnancy, are two incidents where alloimmunisation can occur. Antibodies raised by this mechanism are usually referred to as irregular blood group alloantibodies. Alloantibodies can be present following no known immunisation, and as such are referred to as naturally occurring alloantibodies.

The detection of clinically significant blood group alloantibodies is a critical test in pre-transfusion testing of both blood donors and blood recipients. Detection of clinically significant antibodies allows the provision of safe blood to the patient, which should lack the antigen to which the patient has raised an antibody. Failure to detect clinically significant antibodies can cause transfusion reactions, which in some cases may be severe, or even fatal.

Conventionally the antibody screen test has been carried out as an agglutination test in a test tube. This involves the use of human RBCs of known specificity, tested against plasma or serum samples. Following an incubation period, and most often addition of secondary antibody solutions, the mixture is viewed for haemagglutination. More recently this test has also been carried out using microplate and column agglutination technology systems, (e.g. DiaMed ID System, Ortho Clinical Diagnostics BioVue) which can also be used with a degree of automation. The methods and detection limit requirements vary depending on whether testing donors or patients samples; for donors a papainised group OR₁R₂K positive cell is used with a detection limit of 0.5 IU/mL of anti-D, for patient testing techniques are more sensitive and the detection limit is 0.05 IU/mL of anti-D. The most commonly used method used for donor testing uses a rather crude and insensitive method. Whilst compliant with current regulatory requirements, the current test is very limited in the range of clinically significant antibodies it can detect (this uses a papainised group OR₁R₂K positive cell on the Olympus blood group assay). Detection of a wider range of clinically significant blood group antibodies in donors will further improve the safety of blood transfusion medicine, as well as the further benefits suggested herein by use of the multiplexing technology.

Blood group antigens vary greatly in structure and complexity and are predominately carbohydrate or protein in nature; carbohydrate antigens may be simple or highly branched structures, protein antigens may be attached to the outer membrane or integral to the membrane (transmembrane) crossing it many times, and may be glycoprotein in nature.

Routinely, most antibody screening assays involve the use of whole RBCs in solution. More recently, solid phase blood typing using RBC ghosts (i.e. empty cell membranes) has been demonstrated (Immucor Inc. USPO 5,030,560) and in some labs is routinely used for antibody screening. This method is expensive, and is known to miss occasional IgM antibodies of certain specificities, and IgG antibodies of various specificities. Miniaturisation can improve cost efficiency due to low reagent consumption which is important especially in case of RBC of rare specificities. Miniaturised assays such as microarray based have also increased reaction kinetics, and often better sensitivity (Ekins, 1998). However, with spot sizes between 50 and 700 μm, and most frequently between 100 and 250 μm, whole or lysed RBC (“ghosts”) represent rather large structures for spotting. In addition, whole cells are not very stable over prolonged time. Cellular membrane fragments as probes on a microarray have been used (Corning, US2002019015; US2004213909; WO2005010532; WO2006058237) to study G-protein coupled receptor interactions. However, membrane fragments from RBC have not been described. More specifically, membrane fragments from RBC or other (e.g. transfected) cells have not been used for detection of blood group antigen alloantibodies before. The Corning group have, in the above described patents, used immobilization of membrane fragments on various slide surfaces with the best results on gold coated slides, with polyethyleneimine linker/modifier. Gold coating is rather expensive, and can pose problems for certain types of scanners, as it is not transparent. The red cell is between 7.5 and 8.5 μm in size, and has an average lifespan of 120 days. Red cells expressing certain low frequency antigens of interest are often quite rare. The nature of miniaturization means nanolitre/microlitre volumes of each probe cell preparation are required for the test, alleviating problems of rarity when referring to certain blood group antigens, as donations can be used to prepare large quantities of stock antigen. Enzymatic treatment of red cells is known to alter cell surface charge and remove certain structures from the cell. Such treatment can optimise detection of many blood group antigens. Protein blood group antigens (epitopes) may also be represented by peptides consisting of the antigenic determinant sequence and use of such peptides for antibody screening has been demonstrated. However, peptides can normally work only for linear epitopes, and recombinant antigens are unable to support proper conformation in case of multipass transmembrane proteins.

Genetically modified cells can be prepared which display recombinant blood group antigens on their surface. This has been demonstrated for Kell, Knops and Duffy system antigens to date (Ridgwell et al., 2000; Yazdanbakhsh et al., 2000; Sheffield et al, 2006; Patent number WO2005024026). However, while these antigenic forms have been used successfully for antibody screening of human plasma/serum, the range of specificities has been limited. In addition, detection methods have mainly involved flow cytometry—a method which offers low throughput and is accessible to few laboratories and would require adaptation to solid phase. Some have been performed in ELISA or immunoblotting formats. The use of such cells solves problems of short shelf-life and avoids potential biohazard risks. Fragmentation of such cells expressing blood group antigens is previously undescribed.

We have now found that blood group antigens expressed using fragmented RBC membranes and other antigen expressing cell lines can be immobilized to a solid surface, be processed and retained on the surface and maintain antigenicity, and that microarray technology can be used to detect antibodies present in blood samples. This provides an effective alternative test to conventional antibody screening testing, and which can, moreover, be readily integrated into a single microarray with other tests important in blood processing—including blood grouping phenotyping for multiple antigens on the surface of the RBC, Direct Antiglobulin Testing (DAT), microbiological and pathogen testing.

A first aspect of the invention provides an assay for the detection of antibodies to blood group antigens, which comprises:
a solid substrate having immobilised thereon a fragment of cell membrane which presents a blood group antigen capable of binding to a blood group antibody.

A second aspect of the invention provides a corresponding method of blood testing using the assay.

Thus, the present invention envisages the use of cell membrane fragments:

homogeneous small size fragments better suited for microarray printing;
minimalisation of unnecessary material of cell origin, adsorbed or associated with RBC ghosts, especially if membrane fragments are prepared by sonication, as it is in current invention: this should reduce the assay background (noise) values.

However, it is known that in the process of cell fragmentation artifacts can be created, with membrane fragments creating vesicles closed on themselves, in some cases in wrong orientation. The process must be carefully controlled. It was therefore surprising to find that fragmented RBC membranes further processed by immobilization (spotting) on solid phase microarray surfaces, performed as well as, or better than intact RBC or ghosts of same specificity (see results).

A third aspect of the present invention provides, a blood testing method suitable for use in the detection of clinically significant blood group antibodies in blood samples, which method comprises the steps of:

providing a microarray having immobilised on a substrate at discrete pre-defined positions, a plurality of blood group antigens which are capable of binding specifically to different said characteristic antibodies;
contacting a blood sample from the subject with said microarray;
substantially removing any unbound antibodies from at least an area of said substrate to which said binding agents are bound; and
detecting the presence of antibodies bound to said microarray, in order to determine the presence of any said characteristic antibody present in the subjects blood.

Whilst the use of protein/antigen microarrays for binding antibodies has been previously known, it is surprising that the membrane fragments bound by solid substrate can both survive the further processing required and remain attached thereto and thereby captively held to the microarray and, having maintained antigenicity, then be successfully used for the purpose of blood group antibody screening. Cell membrane fragments can be made in any known manner. Preferably, the whole cells are lysed by hypotonic lysis or other known method to release the cell contents and leave the empty cell membrane (cell ghosts). The cell ghosts may be fragmented by sonication, freeze/thaw, spinning etc. The cells may be pretreated with proteases to optimise certain antibody-antigen interactions. Typically, cell fragments are of a size less than 1 μm (e.g. <0.5 μm or <0.3 μm) and often in the range 0.1-0.5 μm. The fragments can be screened to sizes best suited for spotting onto the solid substrate. Further processing may involve initial blocking and then washing of the microarray to remove unbound matter and reduce non-specific binding, plus drying to allow scanning to be performed.

While microarrays represent a comparatively new technology, its benefits and uses are well known by those in the field. Most of the publications relating to microarray technology refer to the use of genetic materials being used as probe and target. Microarrays are most commonly prepared by employment of specialized robotics to deposit micro or nano sized spots of probe samples onto a solid substrate. The multiplexing feature offered by this technology offers tremendous advantages. Thus, one sample may be assayed simultaneously against almost limitless numbers of probes; in comparison to one target-one probe assays of the past. Multiplexing also brings options of increased speed and throughput. These in turn can lead to decreased costs; reduced staff, reduced samples, reduced reagents, reduced sample repeats as microarray can include high levels of replicates with increased levels of data generation, and more efficient data reconciliation being possible.

The assay of the present invention may be included in a single test system which combines antibody screening, blood grouping, phenotyping, DAT and syphilis testing. This may improve the efficiency and effectiveness of blood test procedures by allowing both the screening and potentially identification of different characteristic antibodies. This will help to minimize delays in determining the clinical significance of the distinguishable factors.

Other tests which may be included include:

Human Immunodeficiency Virus (HIV), Hepatitis B, Hepatitis C, Human T-lymphotropic virus (HTLV), microbiology and platelet screening.

It will be appreciated that the choice of membrane-bound antigens provided on the assay will depend on the identity of the target characteristic antibodies. In general the antigens would correspond to those used in conventional antibody screening testing i.e. at least expressing antigens A, B, C, c, D, E, e and K. They may include modified antigens to optimise binding of certain antibodies. Advantageously one could also include other known clinically significant antigens, such as, antigens to antibodies present in differing populations (e.g. Diego).

In particular, the fragment(s) of cell membrane may present all clinically significant blood group antigens, including those from blood group systems ABO and H, Rhesus, Kell, Duffy, Kidd, Lewis, MNS, P, Lutheran, Wright, Diego, Colton and Xg. These are set out below.

| | Antigens (there are |
|---|---|
| Blood Group System | more but these are ‘clinically sig’) |
| ABO and H | A(A₁ and A₂), B, H |
| Rhesus | C, D, E, c, e, C^{w} |
| Kell | K, k, Kp^{a}, Kp^{b}, Js^{a}, Js^{b} |
| Duffy | Fy^{a}, Fy^{b} |
| Kidd | Jk^{a}, Jk^{b} |
| Lewis | Le^{a}, Le^{b} |
| MNS | M, N, S, s, Mi^{a}, U |
| P | P1, Tj^{a} |
| Lutheran | Lu^{a}, Lu^{b} |
| Wright | Wr^{a} |
| Diego | Di^{a}, Di^{b} |
| Colton | Co^{b} |
| Xg | Xg^{a} |

The blood group antigens immobilized on the substrate may be RBC membrane fragments or antigens expressed in alternative cell lines. To allow sufficient control of the test, relevant control probes are preferably also included. Such positive controls may include antibodies to demonstrate addition of test materials, for example anti-human Ig. Negative controls include buffers used in probe preparation, blocking agents and may also include same type cells/probes from other species/sources modified and treated by the same methods as our testing probes.

The solid substrate is preferably provided with a coating which supports the membrane fragments carrying the blood group antigen. The coating is preferably thick enough to effectively anchor the membrane fragment in a manner which allows the antigen to be effectively presented; such that the blood antibody being tested for can form an effective immune complex. Usually the coating is at least one molecule thick, particularly at least 0.1 micron, especially at least 1 micron, more especially at least 10 microns thick. The coating thickness can be up to 100 microns, e.g. up to 10 microns thick. Preferred ranges are from 1 to 100 microns (particularly 5 to 20 microns) thick. The coating material may be any material known in the art as being suitable for coating solid surfaces for the purpose of immobilising biological materials. Usually the coating material is hydrophilic and water soluble and is applied as a solution which is dried to leave a solid or semi-solid coating on the surface.

There are many suitable surface modification and coating materials, such as natural and synthetic gums, gels and polymers. Suitable polymers include polyethylene glycols such as oleyl-o-poly (ethylene glycol)-succinyl-N-hydroxy-succinimidyl ester; polymeric bases, particularly polymeric nitrogen bases and especially quaternary nitrogen bases, such as polydiallyl dimethyl ammonium chloride; and polypeptides such as poly-l-lysine. Suitable silanes include 3-glycidoxypropyl-trimethoxysilane.

Solid surfaces, most often glass for microarray slides, can be modified with GAPS (gamma aminopropyl silane), APTS (3-aminopropyltriethoxysilane), epoxy silane and GOPS (3-glycidoxypropyl-trimethoxysilane). Common polymer coatings include poly-L-lysine (PLL). Polyacrylamide patches can form a three dimensional structure. Glass can also be coated with membranes, such as nitrocellulose or PVDF. For membrane fragment immobilisation, it is important to preserve flexibility of lateral movement in the polymer coating material, in other words it is preferred not to immobilise membrane fragments directly onto the solid surface. This can be achieved by using a suitable polymer cushion between the surface and the immobilised membrane fragment material. Gold surface and polyethylenimine cushions work well, but are expensive. The present invention is designated for high throughput blood screening and the cost of such coating would be prohibitive. We have analysed various potential polymer surfaces including Sunbright preparations (oleyl-O-poly(ethylene glycol)-succinyl-N-hydroxy-succinimidyl esters; NOF Corporation, Japan). The present invention focuses on the use of membrane fragments ideally with a long shelf life and which are treated and processed very differently from live cells. RBC are rather different from other tissue culture eukaryotic cells. It was therefore surprising to find out that sonicated RBC membrane fragments of small size (typically less than 0.5 μm) and often treated with particular proteases to optimise certain blood group antigen—antibody interactions, can still be retained on Sunbright coated surfaces and successfully used in antibody screen assay.

Another polymer, polydiallyldimethylammonium chloride (pDADMAC) is normally used in large industrial water treatment applications, and has not been used for coating solid phases for microarray purposes before. Its cost is significantly lower than that of gold coated solid phase, or indeed most other coating agents. It was very surprising to us how well this polymer worked for membrane fragment immobilisation. In addition, control protein molecules such as antibodies were also successfully immobilised (see Results), suggesting potential wide use of pDADMAC coated slides, microplates and other solid surfaces for bioassays, and in particular microarray based bioassays according to the present invention.

Typically, the antigens are bound to the substrate in an array. As used herein the term “array” refers to a generally ordered arrangement of immobilised antigens, which specifically bind to red blood cell antibodies, on a substrate such as glass or plastics. Typically the array may be in the form of a series of regularly spaced apart delimited areas to which the antigens are bound. Such substrate bound antigen arrays may be described as an “antigen chip”.

The antigens may be arranged on for example, a flat or spherical substrate. Planar arrays are readily scanned by automatic equipment. Moreover, each specific antigen may be provided in a number of dilutions and/or repeated a number of times (e.g. 3-10 times), in order to minimise any false positive or negative reactions that may occur, when carrying out an assay method.

The array can be formed on any conventional substrate, for example plates or beads formed of glass, plastics, silicon, silicon oxide, metals or metal oxides. The substrate can have a variety of surface forms, such as wells, trenches, pins, channels and pores, to which the antibodies are bound. Multi-well microplates are preferred. Preferred substrate surface architecture for improving fluorescent detection are described in WO02/059583 and WO03/023377. In certain embodiments, the substrates are preferably optically transparent.

Generally speaking the assay of the present invention may comprise small planar substrates, such as rectangles of side 50-100 mm, with up to 10000 spots of antigen per slide or microplate. Conveniently each antigen may be spotted, printed or otherwise provided on the substrate using known techniques, see for example Michael J. Heller, Annual Review of Biomedical Engineering, 2002 Vol. 4: 129-153. DNA Microarray Technology: Devices, Systems and Applications. Angenendt, P.; Glökler, J.; Murpy, D.; Lehrach, H.; Cahill, D. J. Anal. Biochem., 2002, 309, 252-260 Angendt, P.; Glökler, J.; Sobek, J.; Lehrach, H.; Cahill, D. J. Chromatogr. A, 2003 100, 997-104. Typical spots are less than 1 mm in diameter, such as less than 500 μm or 100 μm in diameter. Usually, the spot size is from 50 to 1000 μm. In this manner 1-1000, preferably 10-100 antigen spots may be provided in a single array, if so required.

The assay of the present invention may also be used to test more than one blood sample. Each chip may comprise a plurality of separate arrays on the surface of the substrate, arranged to allow separate samples to be contacted with each array in such a way that the samples do not mix. For example, each array may be bounded by a wall, ridge, dam or hydrophobic zone designed to prevent different samples from coming into contact with one another.

One particular example of said structure is a conventional format microplate, but for our purposes with flat glass well bottoms. In this format, there is an array of arrays, typically using a 96 well plate (although 384 well and above sizes are also considered possible) containing 96 arrays of probes. Each well is provided with an array of antigen spots arranged in a predetermined pattern. Each well is able to receive a blood sample to be tested and may comprise a single antigen (possibly at different concentrations) or a multiplicity of antigens. The predetermined pattern allows the array to be scanned automatically and the results read and stored electronically.

Desirably, any areas of the substrate surface not provided with binding agent (and which could provide non-specific binding sites) are treated with blocking agents in order to prevent any non-specific binding of antibodies to said antigens. Various suitable blocking agents are well known in the art. In general they comprise albumin or serum (free of undesirable antibodies such as blood group antibodies, anti-IgG antibodies or those that could interfere with any test probe interactions on the same microarray), such as non-fat milk protein, casein, bovine serum albumin (BSA), etc, conveniently presented in a buffer. One convenient example which may be mentioned is 1 to 4% w/v bovine serum albumin (BSA) (ID Bio, France) in Phosphate Buffered Saline (PBS) (0.15 M sodium chloride, 2.632 mM Phosphate Buffer Stock Solution (Alba Bioscience, Scotland), pH 7.0).

Secondary detection antibodies for antibody screening must react with any bound antibodies (such as human IgG or IgM). This may also apply to antibodies of any immunoglobulin class including IgG, IgM, IgE, IgA, IgD and any subclass thereof.

There are a number of methods for detection of bound biological components, such as tags for luminescence, chemiluminescence, radioisotopes, label-free detection (e.g. Biacore). Fluorescence detection using confocal scanning is most frequently used in microarrays, although imaging systems are presenting themselves as more cost effective, versatile and faster alternative options. As discussed hereinafter, a particularly convenient method of detection of the bound antibodies involves the use of fluorescence-labelled secondary antibody conjugates, which have specificity for the bound antibodies which it is desirable to detect. Presence of fluorescence may be detected using confocal scanning using lasers to excite fluorophores and subsequent detection of emission, or alternatively by illumination methods such as LED or metal halide lamps and detection by camera image capture.

In the assay method of the invention, any antibodies present in the sample of blood are allowed to specifically react with the immobilised membrane-bound antigens over a period of time, such as 10 seconds to several hours, for example 1 minute to 60 minutes. Typically, this may be carried out at room temperature, but may also be carried out at, for example, 37° C.

Removal of unbound material may be achieved by washing the surface of the substrate with a solution such as water or saline, by blowing or sucking air across the surface of the substrate, by aspiration, or by using centrifugation, or shaking to dispel unbound material from the surface of the substrate. Moreover, areas of the substrate out with the delimited areas to which the antigens are bound, may be porous to cells from the sample being tested, such that the cells may pass through the substrate and are thereby easily removed.

As described above, the presence of the bound antibodies may be detected by means of various techniques known in the art such as secondary labeling detection (fluorescent or chemiluminescent conjugated antibodies) or rolling circle amplification.

Thus, any antibodies bound to the microarray may be detected by a fluorescent signal. By knowing the position of each specific antigen on the substrate, it is possible to identify which antibodies are present in the blood being tested and thus identify the blood group specificity of the antibody in the sample of blood being tested.

Fluorescence may be detected by any suitable photo-detector known in the art, such as a spectrophotometer. Conveniently there may be used a confocal scanner with exciting laser, with the fluorescent output being detected by the scanner and the intensity thereof given a numerical value for purposes of interpretation and data processing.

By using appropriate electronics and software, a suitable device can be programmed to know the identity and location of specific antibodies on the surface of the substrate and to correlate this with fluorescent signals generated, so that particular blood grouping can be determined and identified to the tester. Additionally, statistical software may be included so as to combine and formulate the results from the various repetitions and/or dilutions of the antibodies provided on the substrate. In this manner, the fluorescent signals obtained from a multiplicity of specific antigen spots may be factored together and a statistically significant result displayed to the tester.

Further preferred features and advantages of the invention will appear from the following detailed Examples given by way of illustration.

The results of immunoassays are given in the following figures:

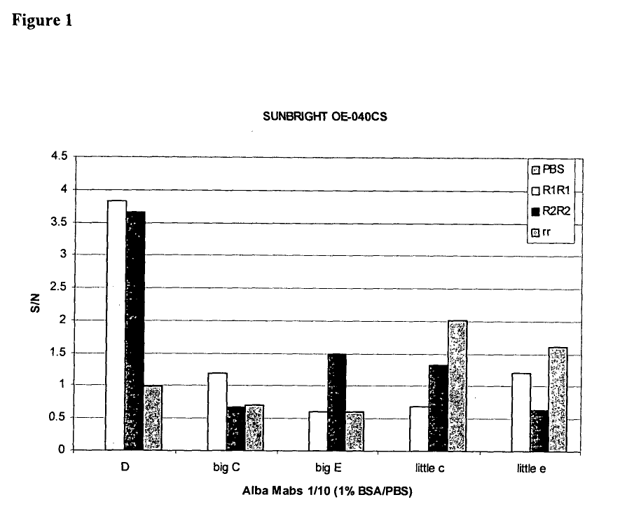

FIG. 1 shows the reactivity of a Sunbright coated slide carrying red blood cell (R₁R₁, R₂R₂ and rr cells) membrane fragments, with a panel of blood monoclonal antibodies;

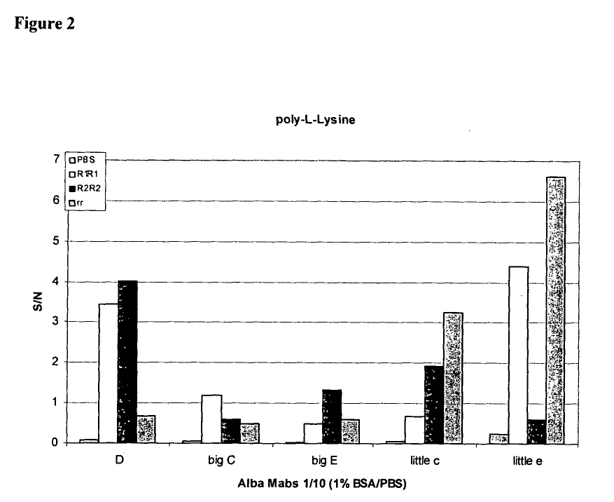

FIG. 2 shows the reactivity of a poly-L-Lysine coated slide carrying red blood cell membrane fragments;

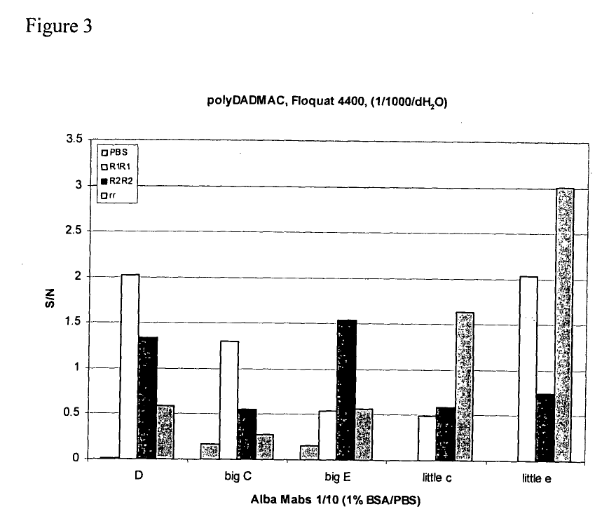

FIG. 3 shows the reactivity of a polyDADMAC coated slide carrying red blood cell membrane fragments;

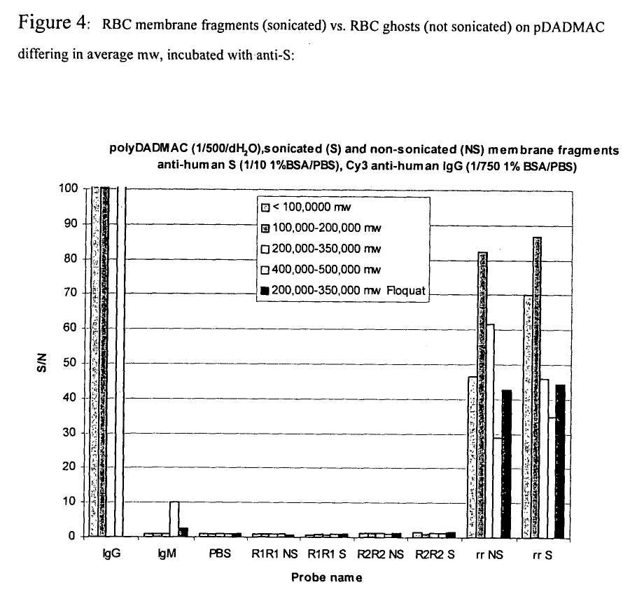

FIG. 4 shows the reactivity of red blood cell fragments (sonicated) versus red blood cell ghosts (not sonicated) on five different pDADMAC preparations differing in average molecular weight;

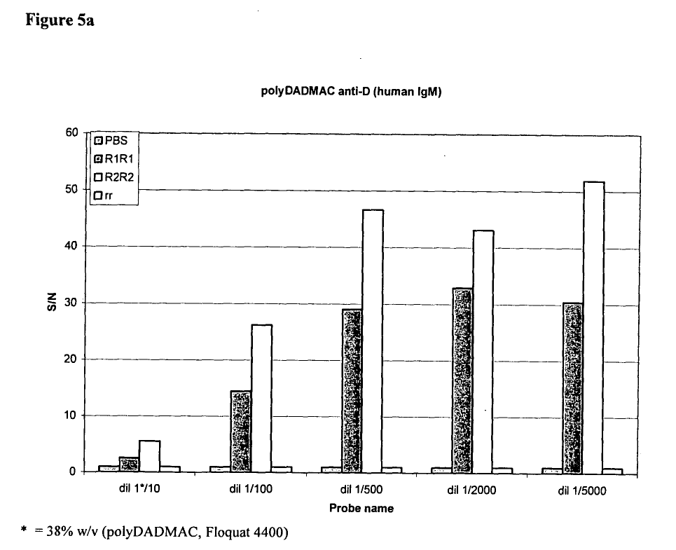

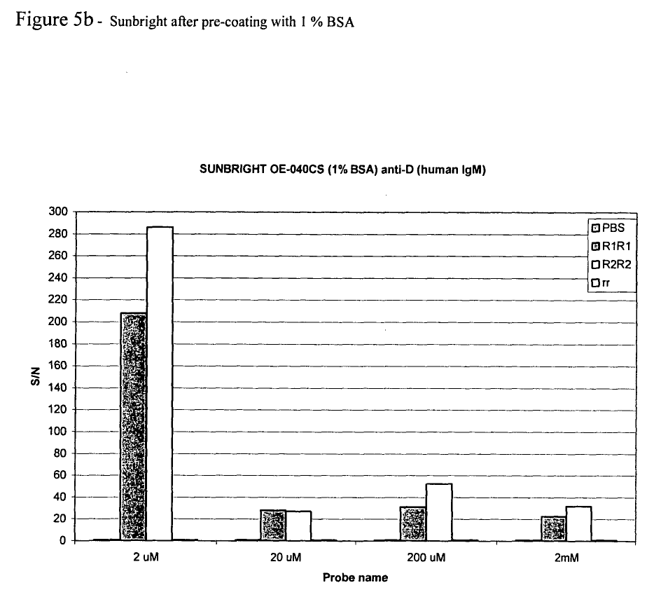

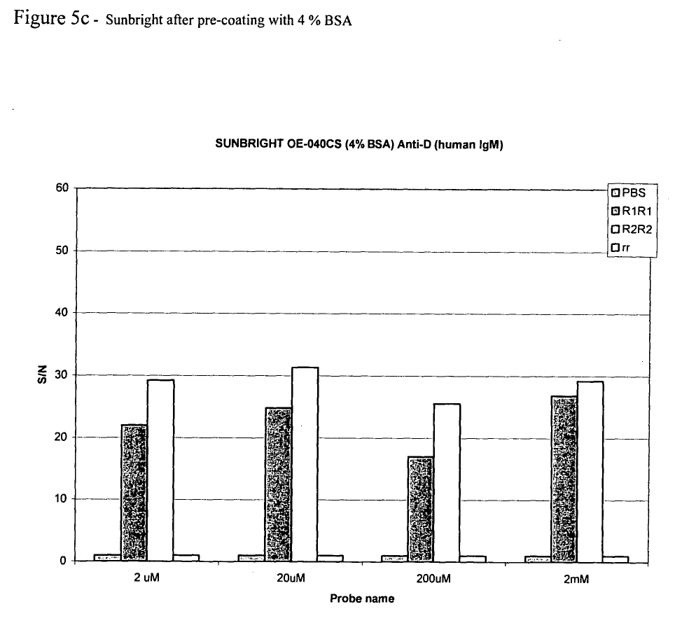

FIG. 5 (a) to (c) shows the effect of increasing the concentrations of coating agents where the antibody is anti-D;

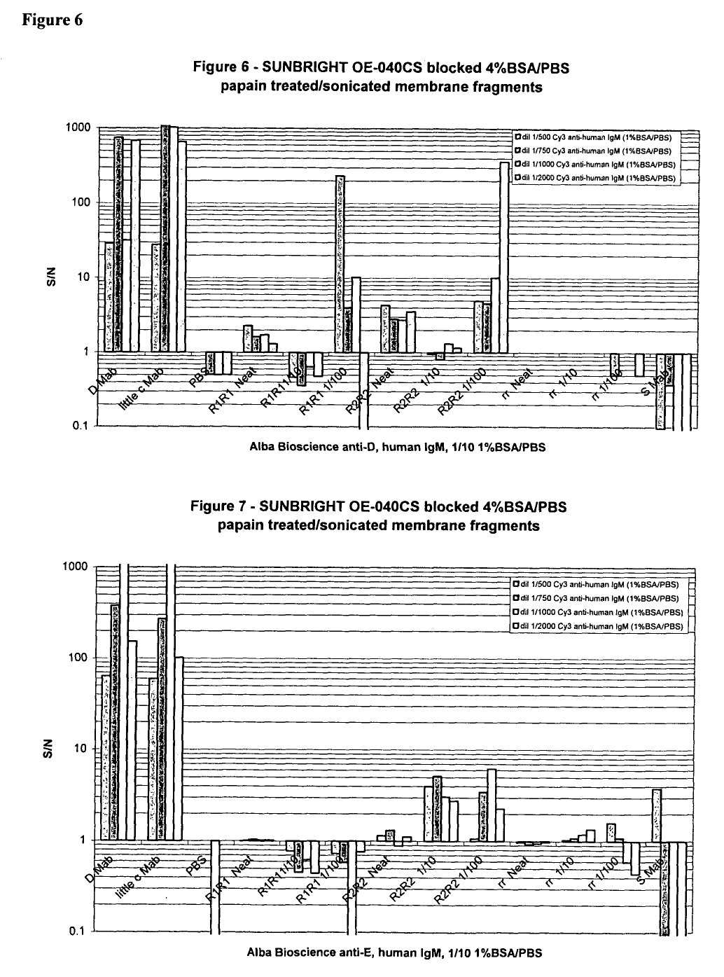

FIGS. 6 and 7 show the reactivity of microarrays coated with Sunbright and carrying membrane fragments of various red blood cell types (R₁R₁, R₂R₂ and rr) against anti-D and anti-E monoclonal antibodies, respectively;

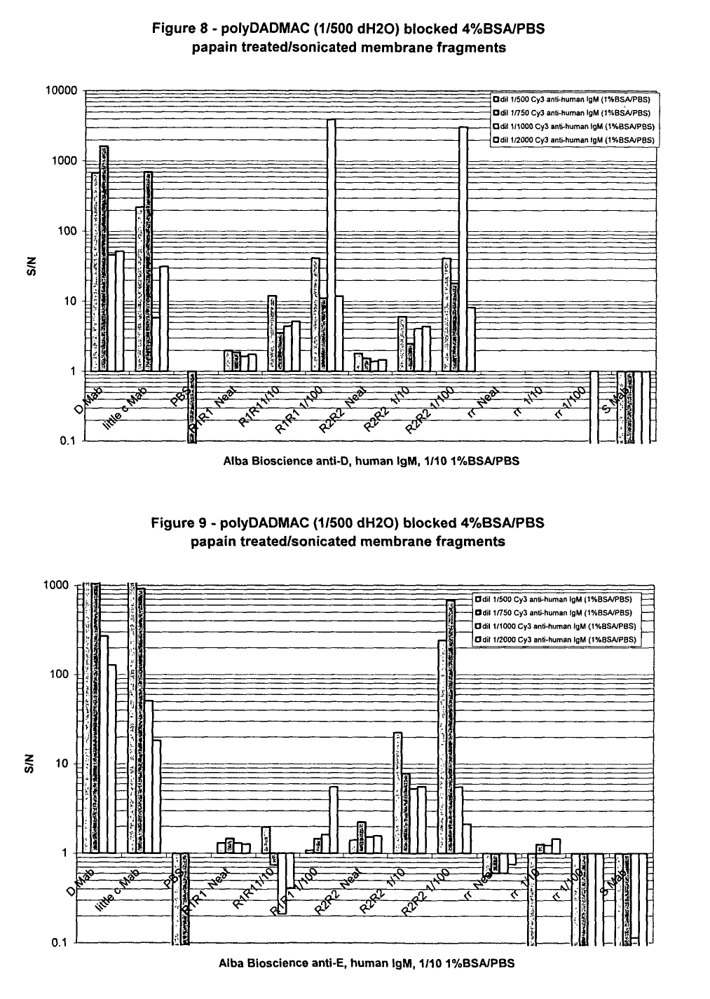

FIGS. 8 and 9 show the analogous reactivity of microarrays coated with polyDADMAC;

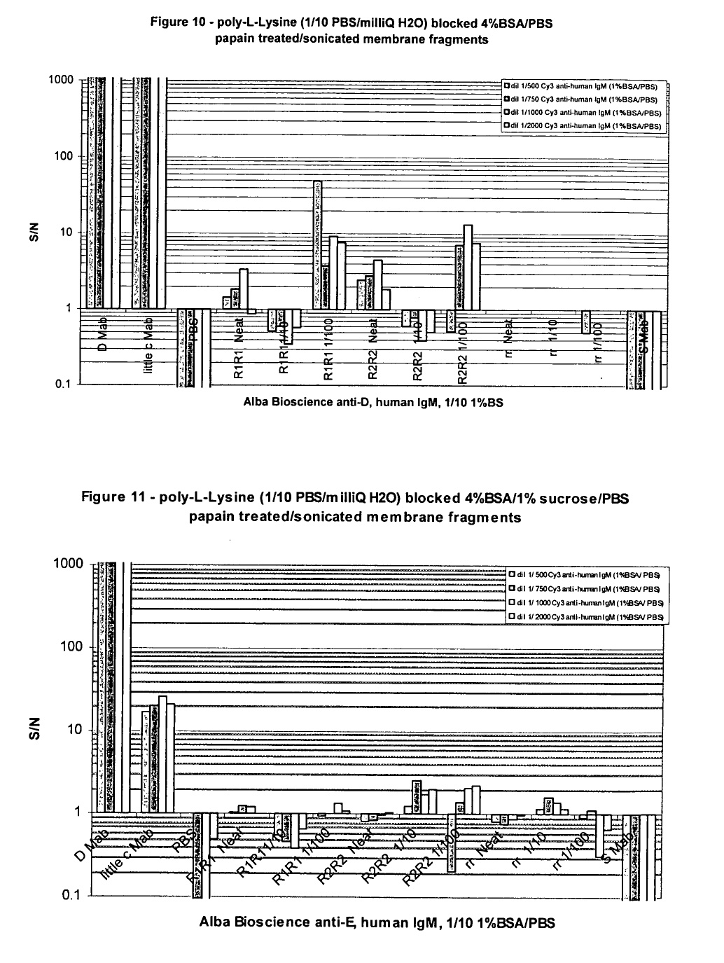

FIGS. 10 and 11 show the analogous reactivity of microarrays coated with poly-L-lysine; and

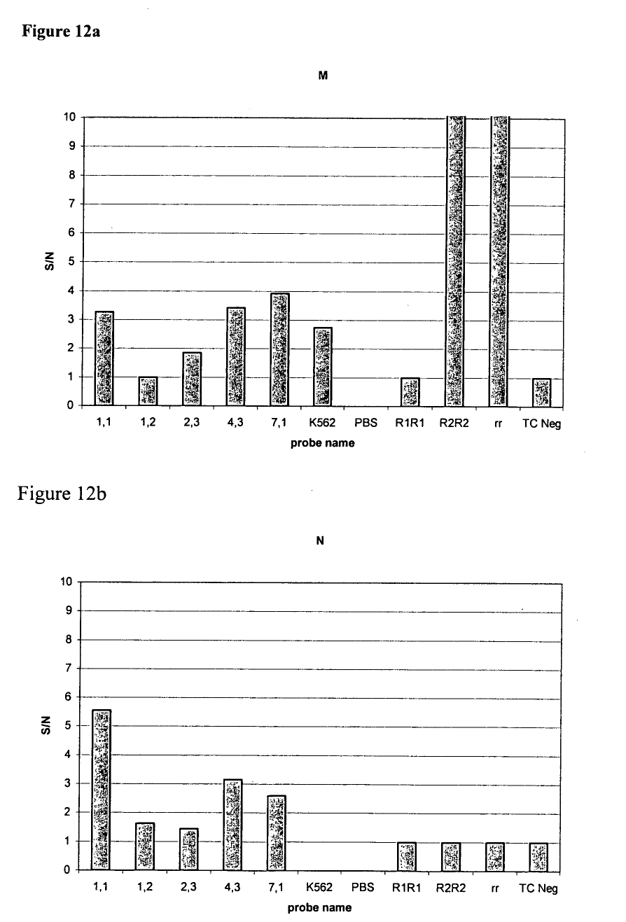

FIGS. 12(a) and 12(b) show respectively the reactivity of slides coated with pDADMAC carrying membrane fragments of colonies (1,1; 1,2; 2,3; 4,3,7,1 etc.) of 293T cells transfected with glycophorin A and B genes (for blood group antigens M/N and S/s respectively), against anti-M and anti-N antibodies.

### EXAMPLE 1

### Preparation of Membrane Fragments from Modified and Untreated Red Blood Cells (RBC)

Human red blood cells expressing antigens of interest were selected from blood donations and/or donor test samples. 3 ml of each appropriate donor blood was pipetted into separate 225 ml falcon tubes and ice cold PBS added to 200 ml. The red cell suspension was mixed gently and then spun at 3000 rpm for 10 min. The supernatant was discarded and the process repeated three times—twice using PBS and once with 310 buffer (0.1 M Na₂HPO₄, pH to 7.3 using NaH₂PO₄) with gentle re-suspension of the centrifuged red cell pellet each time. 5 ml of 310 buffer was added following the last supernatant discard, and then the suspension was mixed gently. The haematocrit (i.e. percentage of the volume taken up by the RBCs) was measured and should be >10% red cells. If required, the haematocrit was adjusted to 10% with 310 buffer. 10 ml of the 10% cell suspension was removed to Sorvall tubes and then filled to 36 ml with ice cold lysis buffer (46.5 mL 310 buffer diluted to 1 L reverse osmosis (RO) water) and mixed gently. This was spun at 19,000 rpm for 15 min at 4° C. The haemolysed supernatant was discarded and the pellet resuspended and washed again in 36 ml of ice cold lysis buffer. This was spun again at 19,000 rpm for 15 min at 4° C. The pellets were gently resuspended with 5 ml of PBS in universal containers and retained on ice. The resultant red cell ghosts (i.e. empty cell membranes) were fragmented by sonication for 1 minute at 50% of maximum power (Status 200 sonicator).

If enzyme modified cells were required, they were treated as follows prior to the ghost and fragmentation process described above. A red cell suspension was washed in PBS until the supernatant was clear (usually 4 times) and then prepared to a 50% haematocrit in PBS. For each 1 ml of 50% red cell suspension, 1 ml of 0.5% papain was added and mixed gently in separate 225 ml falcon tubes. The mixture was incubated at room temperature for 8+/−0.5 minutes with mixing throughout. Following incubation each flask was filled with 0.9% saline or PBS and mixed gently. Each flask was then centrifuged at 3600 rpm for 6 minutes with no centrifuge brake. The supernatant was aspirated to waste using a peristaltic pump. This procedure was repeated at least 3 times until the supernatant was clear. On the final wash the suspension was topped up with Modified Alsevers solution (Alba Bioscience) to a 50% suspension.

### EXAMPLE 2

### Preparation of Membrane Fragments from Transfected Cell Lines Expressing Cloned Blood Group Antigens: M/N and S/s Antigens

Source of RNA: Erythroid cell line K562 is known to express glycophorin A and B, which carry the blood group antigens M/N and S/s, respectively. K562 were grown in RPMI medium enriched with 10% calf serum. 10⁷ cells were used for total RNA isolation using RNeasy mini kit (Qiagen) according to the manufacturers' instructions. A proportion of RNA was used for the synthesis of first strand of cDNA, using AccuScript High Fidelity 1^{st} Strand cDNA Synthesis Kit (Stratagene) in 20 μl reaction. Between 0.5 and 2 μl were used for subsequent PCR amplification of Glycophorin A (GYPA) and B (GYPB) coding sequences. As the N-termini of both proteins are identical, same forward primer was used (SacIIGYP AB fw1). Primers:

SacIIGYP AB fw1:
CATCGACCGCGGGCCACCATGTATGGAAAAATAATCTTTGTAT
EcoRIGYP A r:
GTTCGTGAATTCTCATTGATCACTTGTCTCTGG
EcoRIGYP B r:
GTTCGTGAATTCTCATGCCTTTATCAGTCGGC

PCR conditions: 0.7 μl of cDNA used; 1 μl of each primer (20 pmoles/μl), water to 25 μl and 25 μl of Pfu Ultra Hot Start 2× Master mix (Stratagene).

| | |
|---|---|
| Program: | 95° C./3 min 1 cycle |
| | 95° C./30 sec |
| | 54.5° C./30 sec 35 cycles |
| | 72° C./1 min |
| | 72° C./10 min 1 cycle |
| | 4° C. Hold |

Forward primer contains an extra sequence carrying recognition sequence for restriction endonuclease SacII and reverse primers for restriction endonuclease EcoRI. The PCR products were, therefore digested simultaneously with both enzymes in NEB buffer 4 at 37° C. for 2 hrs and then cleaned with PCR purification kit (Qiagen). Plasmid pCMV-Script (Stratagene), 5 μg was digested with same restriction endonucleases in 20 μl reaction, dephosphorylated after adding 2.5 μl of 10× Antarctic Phosphatase buffer and 2.5 μl Antarctic Phosphatase (5 U/μl), for 15 min at 37° C., and subsequently the enzyme was inactivated at 65° C. for 15 minutes. Linearised plasmid was then purified with PCR purification kit. Purified PCR products and plasmid were eluted into 30 μl of elution buffer.

Ligation: 0.6 μl of pCMV Script plasmid, treated as described above was combined with 2.4 ul of corresponding PCR product and 3 ul of 2× Mighty Mix ligation mix (Takara). Ligation was carried out for 20 minutes at 16° C.

Transformation: 4 ul of ligation mixes were used to transform 50 ul aliquots of E. coli Top 10 chemically competent cells (Invitrogen) according to manufacturers' instructions. 250 ul of SOC medium was added and cells grown for 1 hr at 37° C. for 1 hour with shaking 225 rpm, to recover before plating. 20 and 200 ul of each transformed cells were plated on L-agar plates containing 50 ug/ml kanamycin.

Preparation of recombinant plasmids: 4 colonies from each transformation were grown overnight in 5 ml liquid LB medium containing 50 ug/ml kanamycin at 370° C., with shaking 250 rpm. Plasmid minipreps were prepared using Qiagen miniprep kit, according to manufacturers' instructions and eluted into 50 ul elution buffer. 3 ul of each plasmid DNA was digested in NEB buffer 4 simultaneously with SacII and EcoRI restriction endonucleases (NEB) to check for presence of cloned insert, using electrophoresis in 1% agarose/TBE gel and ethidium bromide staining.

Transfection: Plasmid DNA was quantified by UV spectrophotometry at 260 nm and 15 ug of each plasmid DNA was mixed with 45 ul of GeneJuice ( . . . ) to transfect 293T cells using electroporation. The cells after electroporation were plated onto 10 cm Petri dishes in RPMI medium enriched with 10% calf serum. Cells from ½ of the plates were collected 24 hours after transfection, another half after 48 hours by scraping cells off, spinning, washing with PBS, spinning again, and snap-freezing the cell pellets.

Preparation of Membrane Fragments from Transfected Cells:

Membrane fragments were prepared using the same sonication method as for red cells (Example 1). The number of cells, however, was much smaller and, consequently, the dilution factor larger for fragments from transfected 293T cells.

### EXAMPLE 3

### Preparation of Coated Slides and Plates

General materials: Bovine Serum Albumin (minimum 96% electrophoresis) was purchased from Sigma-Aldrich Company Ltd, Dorset, UK. PBS tablets (1 tablet per 100 ml) were purchased from Scientific Laboratory Supplies Ltd, Nottingham, UK or Alba Bioscience in-house PBS was used.

Microplates: 96-well glass-bottomed Matrix microplates were purchased from Matrix Technologies Corporation, UK and 96-well glass-bottomed Porvair microplates were purchased from Porvair Sciences Limited, Shepperton, UK.

Coating Reagents: Oleyl-O-poly(ethylene glycol)-succinyl-N-hydroxy-succinimidyl ester, SUNBRIGHT OE-040C [which has an average of 90 ethylene oxide repeat units in the polyethylene glycol (PEG) moiety and a MW of 4000], was purchased from NOF Europe (Belgium). Medium molecular weight polydiallyldimethylammonium chloride (polyDADMAC), FL 4440,% active 39-42, was a kind gift from SNF (UK) Ltd, Castleford, UK. Poly-L-Lysine solution PLL (0.1% w/v in water) and 3-Glycidoxypropyl-trimethoxysilane, 98%, (GOPs) was purchased from Sigma-Aldrich Company Ltd, Dorset, UK.

### Methods

Slide Cleaning: Slides were cleaned in 50 g NaOH/250 ml 96% EtOH/200 ml MilliQ purified water for 2 h, shaking gently at room temperature.

Microplate Cleaning: A 200-μl volume of 0.2 M NaOH was pipetted into each of the 96 wells of the microplate and left at room temperature for 30 min. The plate was washed 2×3 times with reverse osmosis purified water (RO water) using a Dynex Ultrawash Plus ELISA microplate washer. A further 200 μl volume of 90% EtOH was added to each well and left to incubate at room temperature for 30 min. The microplate was washed as previously described. Each microplate was centrifuged upside down using an IEC Centra-4B centrifuge at ˜40,000 rpm for 5 min at room temp. to dry the plate.

### Microplate Coating

Poly-L-Lysine: A 100-μl volume of Poly-L-Lysine (0.1 mg ml⁻¹, diluted in 10% PBS/RO water) was pipetted in to each well and left overnight at room temp. Unbound PLL solution was washed off with 100 μl RO water X 2 using an automatic pipette, and centrifuged dry as described above. The plates were placed in an oven at 40° C. for 5 min.

GOPs: A 100-μl volume of GOPs (˜10 mg ml⁻¹ in 94% EtOH/RO water) was pipetted in to each microplate well and left overnight at room temp. Unbound GOPs solution was washed off with 100 μl % EtOH/RO water X 2 using an automatic pipette, and centrifuged dry as described above. The plates were placed in an oven at 60° C. for 60 min.

SUNBRIGHT OE-040C: A 100 μl volume of 1% BSA/PBS/RO water was pipetted in to each microplate well and left overnight at room temp. Excess 1% BSA/PBS/RO water solution was washed off with 100 μl PBS water X 2 using an automatic pipette, and centrifuged dry as described above. A 100-μl volume of SUNBRIGHT OE-040C (0.08 mg ml⁻¹ in PBS/RO water) was pipetted in to each microplate well and left to incubate at room temp for 1 h. Unbound SUNBRIGHT OE-040C was washed off with 100 μl PBS/RO water X 2 using an automatic pipette, and centrifuged dry as described above.

FL 4440 (polyDADMAC): A 100-μl volume of 0.8 mg ml⁻¹ polyDADMAC was pipetted in to each microplate well and left overnight at room temp. Unbound polyDADMAC was washed off with 100 μl RO water X 2 using an automatic pipette, and centrifuged dry as described above.

Slide Coating: Slides were coated with PLL, SUNBRIGHT OE-040C and FL 4440 (polyDADMAC) using the same concentrations, temperature and incubation times as for microplates.

### EXAMPLE 4

### Preparation of Protein Microarrays

Surface coated slides prepared as described above were used as the substrate. The membrane fragment samples to be spotted were prepared in PBS or other solutions for stabilizing.

The slides were printed using a SpotBot (Telechem/Arrayit) or BioRobotics MicroGrid II Arrayer with solid pins between 200 μm and 700 μm. Replicates of each sample were printed on each slide, and the slides were air dried for at least one hour, before being sealed in a bag and placed at 4° C. until required. The slides were rinsed briefly in PBS before being treated in a container of PBS-BSA blocking agent for one hour at room temperature, with constant mixing. On removal the slides were rinsed briefly in PBS and centrifuged to dryness in a centrifuge at 1000 rpm for one minute.

### EXAMPLE 5

### Antibody Screening Testing of Blood Using Protein Microarrays

Microplate method/A chamber was placed over each of the protein microarrays prepared according to Example 4. A blood sample from a subject was diluted 1 in 10 using PBS. Microplate volume/450 μl of the antibody solution was then pipetted through one of the portholes in the chamber onto the microarray slides. The portholes were sealed with the provided port seals. The slides were placed in a slide box and mixed for one hour at room temperature.

The chamber was removed and slides briefly submerged into PBS to remove excess target solution. This was followed by two washes in PBS for 10 minutes. After the final wash the slides were centrifuged to dryness and stored in a dust-free dark place until scanning. Where indicated, antibodies were obtained from Alba Bioscience, Edinburgh, UK.

### EXAMPLE 6

### Data Extraction and Analysis

Slides were scanned in an Genepix Personal 4100A Scanner or similar. Wavelength settings used were for Cy3/FITC. All slide scans were performed at 10 micron pixel size and saved as both a BMP and a TIF file.

Numerical data was extracted from the microarrays using GenePix Pro 4.1 (Axon Instruments) or similar. The software controls the scanning, data input and date extraction from the microarray. A text input file was self-generated using microarray column and row positions to determine identity and location of each probe. This was used to generate an array list that was loaded once the microarray grid settings had been set up. Once the grid and the array list had been generated, the data was extracted to a text file. This process gave the median fluorescence intensity value from the centre of each spot and a median background value from the entire background area of the slide. This information was collected into an Excel worksheet.

For each spot the background fluorescence value was subtracted from the fluorescence intensity value. For each slide the signal intensity values from each different scan setting were collated into one worksheet. A scatter plot was prepared using all values for each of the settings set against each other. The shape of the resulting data cloud gave an indication of the scan qualities, and can show if settings were too low, or if settings were too high giving saturated spots. The R2 value was applied to each graph and those that gave a value closest to one demonstrated the best data. One scan from each slide was selected for further data processing.

Once the best data scan had been selected it was processed as follows. Unwanted data were removed from the worksheet to leave only one value per spot on the microarray (the fluorescence intensity value minus the background fluorescence value for each spot). The negative control values were used to calculate a ‘noise’ value—the mean plus two standard deviations of the negatives (mean+2sd). This value represents non-specific binding (NSB). The value for each spot was divided by the mean+2sd of the negative controls to give a signal-to-noise ratio (S/N). Values over one can be considered significant. The median of the S/N was calculated for the replicate spots of each sample.

Using Microsoft Excel the processed data was analysed as appropriate. Bar charts were used throughout to analyse data. The Y-axis on the bar charts represents the S/N median for the sample.

### Results

The results obtained are shown in FIGS. 1-12 of the drawings.

FIGS. 1 to 3 show the reactivity of slides coated with Sunbright, poly-L-Lysine and polyDADMAC against a panel of monoclonal antibodies (anti-D, anti-C, anti-E, anti-c and anti-e). Membrane fragments from R₁R₁, R₂R₂ and rr red blood cell types were immobilised. PBS buffer was a control. Fluorescence-labelled secondary anti-human antibodies were employed to detect bound antibody.

A signal to noise ratio (S/N) greater than one is considered to be a positive result. The expected reactivity of the various cell types to antibodies was expected to be (on the basis of their known reactivities):

R₁R₁: D+C+E−c−e+
R₂R₂: D+C−E+c+e−
rr: D−C−E−c+e+

Reference to FIGS. 1 to 3 shows that the expected reactivities were obtained with the immobilised red blood cell membrane fragments on all these surfaces (except for the reactivity of R₂R₂ c antigen, which showed a reactivity of less than unity). This shows that the immobilisation of the cell membrane fragments successfully retained the antigenicity of various antigens.

FIG. 4 compares the reactivities of red blood cell membrane fragments (sonicated) with red blood cell ghosts (non-sonicated) on pDADMAC of various molecular weights and incubated with anti-S antibody.

*NS: non sonicated (ghosts); S: sonicated (membrane fragments)
RBC S/s phenotypes:
R₁R₁: S−s+
R₂R₂: S−s+
rr: S+s−
   Expected reactivity: only rr positive
   IgG: directly spotted positive control for secondary antibody.
   Floquat was the preparation used in all other previous experiments.

Conclusions: All pDADMAC preparations seem suitable. Those with smaller average mw seem to give best S/N ratio, at least for anti-S antibody. Membrane fragments (sonicated) provide slightly better results on 3 out of 5 preparations. Additional advantages of fragments (stability, homogenous size etc) may become more apparent on smaller size spots (around 200 μm). Spots used here are about 1 μm, produced by manual spotting.

FIGS. 5a to 5c show the effect of increasing concentration of coating agents, using R₂R₂ and rr cell types as before and anti-D (human 1 gM) antibodies. 1/1000 dilution of pDADMAC and 2 μM Sunbright were coating concentrations for these examples. This experiment was intended to show if increased coating concentrations could improve immobilisation of membrane fragments and, consequently, the results. These results show that the concentrations already used were effective and that increased concentrations did not improve the results.

Conclusions: Reactivities do not improve with increasing concentrations of coating reagents, indicating that even the smallest coating concentrations are saturating.

FIGS. 6 to 11 show the reactivity of microarrays coated with Sunbright, polyDADMAC and poly-L-Lysine respectively and carrying red blood cell membrane fragments (R₁R₁, R₂R₂ and rr) against anti-D and anti-E monoclonal antibodies. The bound antibody was detected using fluorescence labelled secondary detection antibodies (Cy3).

The conditions were as follows: Positive control for secondary antibody: directly spotted anti-D (human IgM) and anti-c (human IgM)

Negative control for secondary antibody: directly spotted anti-S (human IgG) Expected reactivity for RBC membrane fragments from R₁R₁, R₂R₂ and rr cells: For anti-E (human IgM): R₂R₂ positive, rr and R₁R₁ negative

For anti-D (human IgM): R₁R₁ and R₂R₂ positive and rr negative Suggested cut-off for positive reactions is 2.

### Conclusions:

PLL/anti-D: inconsistent reaction pattern: some reactivity on neat, no reactivity on 1/10 dilution, best reactivity 1/100.
PLL/anti E: very weak S/N R₂R₂.
Sunbright/anti D: some inconsistency in reaction pattern.
Sunbright/anti E: better reactivity (1/10, 1/100 R₂R₂)
pDADMAC/anti-D: consistent reaction pattern—increase in S/N with increasing dilution of printed fragments—probably due to diluting out non-specific background signal.
pDADMAC/anti E*: as above
*one false positive signal in R₁R₁ 1/100 dilution/1/2000 secondary Ab.

FIGS. 12a and 12b show the reactivity of pDADMAC coatings carrying membrane fragments from transfected cells (colonies 1,1; 1,2; 2,3; 4,3 and 7,1) and red blood cells (R₁R₁, R₂R₂ and rr). K562, PBS and TC Neg are controls. Membrane fragments were prepared from 293 T cells transfected with pCMV expression plasmids containing coding sequences for glycophorin A and B genes. Membrane fragments prepared from cells were collected 24 hours after transfection.

### RBC Phenotypes:

R₁R₁, K−, Fy (a−), Jk (b−), S−s+, M−, N+
R₂R₂, K+k+, Fy (a+b+), Jk(a−), S+s+, M+, N−rr,
K+, Fy (a+b−), Jk(a+b+), S+s−, M+, N−

Expected reactivity: 1,1; 1,2 and 7,1 are expected to react with M or N (contain cloned gene for glycophorin A):

1,2 does not seem to be reactive;
1,1 reacts better with anti-N monoclonal Ab;
7,1 reacts better with anti-M monoclonal Ab;
2,3 and 4,3 are not expected to react with anti-M or N (contain cloned gene for glycophorin B), although some cross-reactivity may be expected, as the N-termini of both genes (which carry M/N specificity) are identical:
4,3 in particular show some cross-reactivity.
TC—negative control: non-transfected 293 T cells
K 562—used as positive control: erythroid cell line expressing MNS. However, the density of spotted membrane fragments much lower due to lower number of cells used.
PBS: negative control; buffer

### REFERENCES

Robb. J. S., Roy, D. J., Ghazal, P., Allan, J. and Petrik, J. (2006). “Development of non-agglutination microarray blood grouping” Transfusion Medicine. 16, 119-129.
Campbell, C. J., O'Looney, N., Chong Kwan, M., Robb, J. S., Ross, A. J., Beattie, J. S., Petrik, J. and Ghazal, P. (2006). “Cell Interaction Microarray for Blood Phenotyping” Analytical Chemistry. 78, 1930-1938.
Ekins, R. P. (1998). Ligand assays: from electrophoresis to miniaturised microarrays. Clinical Chemistry, 44, 2015-2030.
K. Ridgwell, J. Dixey and M. L. Scott (2000). The production of soluble recombinant Kell antigens and their use in screening human sera for anti-Kell blood group antibodies. Transfusion Medicine. 13, Supplement 1, 9.
Yazdanbakhsh, K., Øyen, R., Yu, Q., Lee, S. Antoniou, M., Chaudhuri, a. and Reid, M. E. (2000). High-level, stable expression of blood group antigens in a homologous system. American Journal of Hematology. 63:114-124.
Sheffield, W. P., Bhakta, V., Branch, D. R. and Denomme, G. A. (2006). Detection of antibodies reacting with the antithetical duffy blood group antigens Fy(a) and Fy(b) using recombinant fusion proteins containing the duffy extracellular domain. Transfus Apher Sci. December; 35(3):207-16.

1. An assay for the detection of antibodies to blood group antigens, which comprises:
a solid substrate having immobilised thereon a fragment of cell membrane which presents a blood group antigen capable of binding to a blood group antibody.

2. An assay according to claim 1, wherein the cell fragments are of a size less 1 micron.

3. An assay according to claim 2, wherein the cell fragments are of a size less 0.5 micron.

4. An assay according to claim 3, wherein the cell fragments are of a size in the range 0.1 to 0.5 micron.

5. An assay according to claim 1, wherein the fragment(s) of cell membrane present antigens A, B, C, c, D, E, e and K.

6. An assay according to claim 5, wherein the fragment(s) of cell membrane present all clinically significant blood group antigens, including A (A₁ and A₂), B, H, C, D, F, c, e, C^{W}, K, k, Kp^{a}, Kp^{b}, Js^{a}, Js^{b}, Fy^{a}, Fy^{b}, Jk^{a}, Jk^{b}, Le^{a}, Le^{b}, M, N, Mi^{a}, S, s, U, Pl, Lu^{a}, Lu^{b}, Wr^{a}, Co^{b}, Xg^{a}, Tj^{a}, Di^{a}, Di^{b}.

7. An assay according to claim 1, wherein the cell membrane fragments are from red blood cells.

8. An assay according to claim 1, wherein the cell membrane fragments are pretreated with protease.

9. An assay according to claim 1, which further comprises positive controls to demonstrate addition of test materials.

10. An assay according to claim 1, which further comprises negative controls selected from buffers used in probe preparation and blocking agents.

11. An assay according to claim 1, wherein the substrate is provided with a coating, which supports the membrane fragments and effectively presents the antigens.

12. An assay according to claim 11, wherein the coating is at least 1 micron thick.

13. An assay according to claim 12, wherein the coating is from 1 to 100 microns thick.

14. An assay according to claim 13, wherein the coating is from 5 to 20 microns thick

15. An assay according to claim 11, wherein the coating material is hydrophilic and water soluble.

16. An assay according to claim 11, wherein the coating comprises a polyethylene glycol containing polymer.

17. An assay according to claim 16, wherein the polyethylene glycol containing polymer is oleyl-o-poly (ethylene glycol)-succinyl-N-hydroxy-succinimidyl ester.

18. An assay according to claim 11 wherein the coating comprises a quaternary nitrogen base polymer.

19. An assay according to claim 18, wherein the quaternary nitrogen base polymer is polydiallyl dimethyl ammonium chloride.

20. An assay according to claim 19, wherein the coating comprises a polypeptide.

21. An assay according to claim 20, wherein the polypeptide is poly-l-lysine.

22. An assay according to claim 21, wherein the coating comprises a silane.

23. An assay according to claim 22, wherein the silane is 3-glycidoxypropyl-trimethoxysilane.

24. An assay according to claim 1, wherein the substrate is a plate or bead; formed of glass or plastics material.

25. An assay according to claim 1, wherein the cell membrane fragments are present on the substrate in an array of antigen spots.

26. An assay according to claim 25, wherein the substrate is a multiwell plate and an array of antigen spots is present in each well.

27. An assay according to claim 26, wherein the spots are less than 1 mm in diameter.

28. An assay according to claim 27, wherein the spots are from 50 to 1000 microns in diameter.

29. An assay according to claim 1, wherein any area of the substrate not provided with immobilised membrane fragments is treated with blocking agent.

30. An assay for the detection of antibodies, which comprises:
a solid substrate which is provided with a coating; the coating comprising a polyethylene glycol containing polymer; and
antigen immobilised on the coating and effectively presented.

31. An assay according to claim 30, wherein the polymer is oleyl-o-poly(ethylene glycol)-succinyl-N-hydroxy-succinimidyl ester.

32. An assay for the detection of antibodies, which comprises:
a solid substrate which is provided with a coating; the coating comprising a quaternary nitrogen base polymer; and
antigen immobilised on the coating and effectively presented.

33. An assay according to claim 32, wherein the polymer is polydiallyl dimethyl ammonium chloride.

34. An assay according to claim 30, wherein the antigens are not present on whole cells.

35. An assay according to claim 30, which further includes tests selected from the group consisting of blood typing, direct antiglobulin testing (DAT), syphilis, HIV, HCV, hepatitis B, HTLV, and platelet screening.

36. A method of testing a blood sample for the presence of antibodies to blood group antigens, which comprises contacting the blood sample with the assay of claim 1, removing unbound antibody and detecting the presence of antibody bound to the substrate.

37. A blood testing method suitable for use in the detection of clinically significant blood group antibodies in blood samples, which method comprises the steps of:
a) providing a microarray having immobilised on a substrate at discrete pre-defined positions, cell membrane fragments presenting a plurality of blood group antigens which are capable of binding specifically to different said antibodies;
b) contacting a blood sample from the subject with said microarray;
c) substantially removing any unbound antibodies from at least an area of said substrate to which said binding agents are bound; and
d) detecting the presence of antibodies bound to said microarray, in order to determine the presence of any said antibody present in the subject's blood.
